(19) United States
(12) Patent Application Publication
(10) Pub. No.: US 2016/0088802 A1
(43) Pub. Date: Mar. 31, 2016

(54) DYNAMIC LIGHT RECIPE FOR HORTICULTURE

(71) Applicant: KONINKLIJKE PHILIPS N.V., Eindhoven (NL)

(72) Inventors: Céline Catherine Sarah NICOLE, EINDHOVEN (NL); Gabriel-Eugen ONAC, EINDHOVEN (NL); Marcellinus Petrus Carolus Michael KRIJN, EINDHOVEN (NL); Esther Maria VAN ECHTELT, EINDHOVEN (NL)

(21) Appl. No.: 14/892,013

(22) PCT Filed: May 14, 2014
(86) PCT No.: PCT/IB2014/061419

§ 371 Date: Nov. 18, 2015

(30) Foreign Application Priority Data
May 24, 2013 (EP) 13169158.6

(51) Int. Cl. A01G 7/04; H05B 37/02; H05B 33/08; A01G 1/00

(52) U.S. Cl. CPC A01G 7/045; A01G 1/001; H05B 37/0227; H05B 37/0218; H05B 33/0872

(57) ABSTRACT

A lighting system and method for the growing of a plant seedling is disclosed, including at least one light source (30) for illuminating the plant seedling (39) with grow light during growth stages of the plant seedling growth process, and a controller for the controlling the spectral power distribution of the grow light emitted from the light source (30) such that the grow light in at least some growth stages of the plant seedling growth process comprises more energy in the blue wavelength range than in other growth stages of the plant seedling growth process. In use cases where the grow light is supplementing available daylight, an additional sensor (33) may be used to measure the amount and spectral composition of daylight and control the grow light such that spectral power distribution of total light received by the plant seedling is controlled accordingly.

### FIELD OF THE INVENTION

The present invention relates to the use of artificial lighting in order to stimulate plant growth and development, a technique that is known as horticultural lighting. More specifically, the present invention relates to a light plan for improved growth of plant seedlings.

### BACKGROUND OF THE INVENTION

In horticulture applications, there are growers specialized in breeding and propagating plant seedlings and growers specialized in growing these plants further in, for example, greenhouses to produce the vegetables from the plants.

In the field of the production of plant seedlings, artificial lighting is used more and more. The artificial lighting may be the main source of light in applications such as city farming and/or multilayer farm factories. In other applications, the artificial lighting provides a supplemental light which is combined with daylight.

In artificial lighting, LEDs are becoming more and more popular because of their low energy consumption, long life time and the design flexibility (e.g. less bulky, emission spectrum). In the horticultural industry, the advantageous effects of LEDs on plant growth are still unknown to a lot of professionals and investments in LED lighting for horticulture application, based on energy saving as such, are not always done because of the uncertain other effects of LEDs on the plants and plant production. Additional benefits of LEDs have to be investigated and translated into value and benefit for the growers.

Current industrial applications of LED technology in horticulture use LEDs or LED luminaires with a fixed light spectrum, which may be optimized for specific plant species and which are controlled in on/off modus similar to the use of conventional (e.g. HID) artificial lighting. The fixed light spectra typically have a component in the blue, red and far-red wavelength range. Examples of LED luminaires for horticulture application include the Philips GreenPower LED modules.

### SUMMARY OF THE INVENTION

When growers grow plant seedlings, certain morphological aspects of the seedlings are preferred, like for example large leaf area, solid stems and high biomass. These and other quality attributes of plant seedlings are important for the future growth of the plant in the greenhouse and for the total vegetable production at the end. It is therefore an object of the invention to improve control over and fine tune morphology of plant seedling. It is a further object to improve the plant seedling production process in respect of, for example, time to market of the seedling, growth rate or quality.

A seedling is a young plant developing out of a plant embryo from a seed. Seedling development starts with germination of the seed. A typical young seedling consists of three main parts: the embryonic root (radicle), the embryonic shoot (hypocotyl), and the seed leaves (cotyledons). The two classes of flowering plants are distinguished by their numbers of seed leaves: monocots (monocotyledons) have one blade-shaped seed leave, whereas dicots (dicotyledons) possess two round seed leaves. Part of a seed embryo that develops into the shoot bears the first true leaves of a plant. Dicot seedlings grown under appropriate light conditions develop short shoots and open the seed leaves exposing the epicotyl, i.e. the embryonic shoot above the seed leaves. Once the seedling starts to photosynthesize, it is no longer dependent on the seed's energy reserves. The first “true” leaves expand and can often be distinguished from the round seed leaves through their species-dependent distinct shapes. While the plant is growing and developing additional leaves, the seed leaves eventually senesce and fall off. The seedling growth and development process is illustrated in FIG. 1. The seedlings sense light through the light receptors phytochrome (red and far-red light) and cryptochrome (blue light).

The inventors have found that the plant seedling production process can be improved by varying the amount of artificial light provided at different growth stages during the seedling growth process from seed to seedling. In particular, the inventors have found that providing the seedling with additional blue light in early growth stage, e.g. in the stage of developing the seed leaves and the first true leaf, is beneficial for improving biomass and leaf area of the final seedling plants. It is believed that this effect of additional blue light improves building and preparing the leaves for the photosynthesis process a.o. by opening the stomata. The red light in later stages of the seedling growth process is then used to efficiently drive the photosynthesis process.

Often light spectra for growing plants are specified in terms of a blue/red ratio, a red/far-red ratio, a photon flux in μmol/s etc. The light spectrum may be provided by combining separate blue, red, far-red (and possibly further) light sources or may be provided by a pre-configured light source emitting a light spectrum complying with blue/red and red/far-red ratio's and photon flux as desired. The term “additional” blue light in some of the growth stages refers to a “higher” blue/red ratio in the light spectrum of the grow light, relative to a blue/red ratio known from prior art light spectra for growing plant seedlings or relative to a blue/red ratio used in other growth stages not using the additional blue light.

Accordingly a lighting system is disclosed for the growth of a plant seedling, including at least one light source for illuminating the plant seedling with grow light during growth stages of the plant seedling growth process, and a controller for the controlling the spectral power distribution of the grow light emitted from the light source such that the grow light in at least some growth stages of the plant seedling growth process comprises more energy in the blue wavelength range than in other growth stages of the plant seedling growth process. In embodiments, the additional blue light is provided in at least one of the growth stage where the seed leaves develop and the growth stage where the first true leaf develops.

In embodiments, the growth process of the plant seedling is executed in the presence of daylight and the lighting system includes a sensor for measuring the spectral power distribution of the daylight and the controller is further adapted to control the spectral power distribution of the grow light emitted from the light source based on the spectral power distribution of the daylight and the desired additional blue light, if applicable in the growth stage.

In another aspect, a horticulture production process is disclosed for growing a plant seedling. The process includes providing a light source for illuminating the plant seedling with grow light and controlling the spectral power distribution of the grow light such that the grow light in at least some growth stages of the plant seedling growth process comprises more energy in the blue wavelength range than in other growth stages of the plant seedling growth process. In preferred embodiments, the process includes providing the additional blue light in at least a growth stage where the seed leaves develop and the growth stage where the first true leaf develops.

The invention also relates to a method to control plant seedling morphology by using a LED light recipe, changing dynamically in time, with a defined pattern, depending on the growth stage of the plant seedling in the growing process. The LED light recipe in the presence of varying daylight may further be adjusted continuously such that the overall blue/red, red/far-red and PSS (phytochrome stationary state) value of the total grow light (artificial light and daylight) is in line with the light recipe for the various stages of the growth process.

The lighting system and horticulture production process for growing plant seedlings provides the advantages of a better control over the production of plant seedlings and seed propagation, a predictable growth rate and quality, a shorter time to market, a better control on morphological attributes of a plant seedling (e.g. leaf area, stem length and thickness, total biomass) and providing plants with a higher biomass.

Particular and preferred aspects of the invention are set out in accompanying independent and dependent claims. Features from the dependent claims may be combined with features of the independent claims and with features of other dependent claims as appropriate and not merely as explicitly set out in the claims. For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

### BRIEF DESCRIPTION OF THE DRAWINGS

FIG. 1 is an overview of the plant seedling growth process.

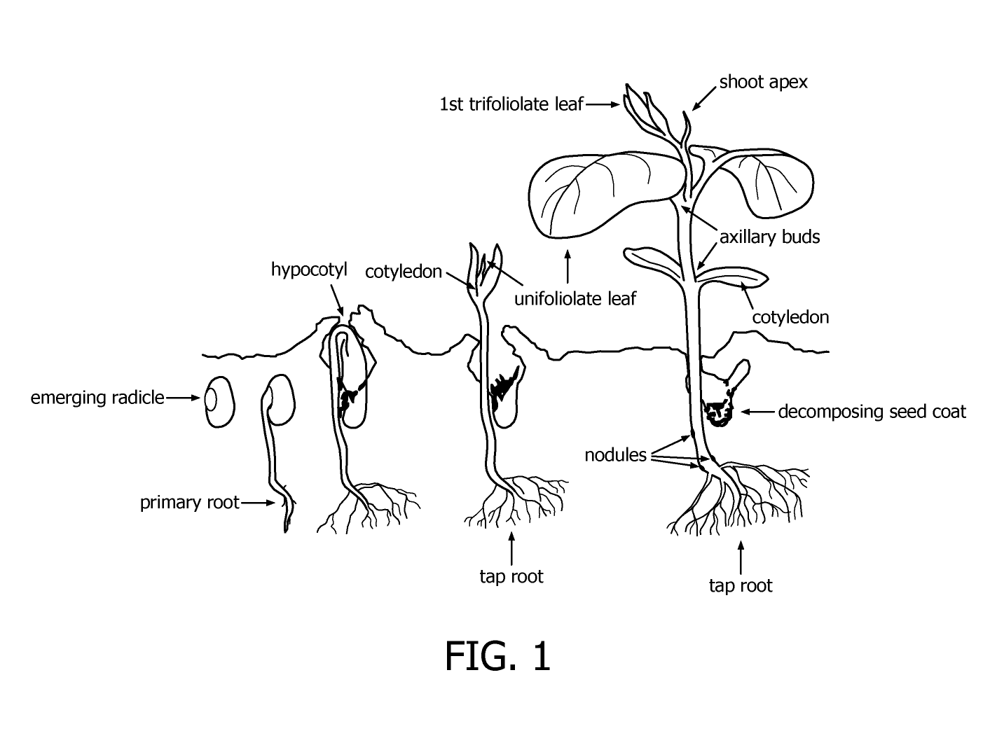

FIG. 2 is a lighting system according to an embodiment of the invention.

FIG. 3 is a lighting system according to another embodiment of the invention.

FIG. 4 shows an embodiment of a dynamic light recipe according to an embodiment of the invention.

FIG. 5 shows the light history during experiments using an illumination according to an embodiment of the invention (red) and a control experiment (black).

FIG. 6 shows a fresh weight increase due to a dynamic light recipe according to an embodiment of the invention versus a daylight illumination.

FIG. 7 shows a leaf area index (LAI) increase in experiment on cucumber seedling using a dynamic light recipe according to an embodiment of the invention.

The drawings are only schematic and are non-limiting. In the drawings, the size of some of the elements may be exaggerated and not drawn to scale for illustrative purposes.

Any reference signs in the claims shall not be construed as limiting the scope. In the different drawings, the same reference signs refer to the same or analogous elements.

### DETAILED DESCRIPTION OF ILLUSTRATIVE EMBODIMENTS

In the present description, the term “light recipe” is defined as the light provided by a luminaire (e.g. based on LEDs, OLEDs or Lasers) and providing a controlled amount of photons in a controlled spectral range during a certain time. In other words, a recipe defines spectrum and intensity of light during a certain time. Luminaires could be designed which are color tunable and intensity dimmable in order to implement several light recipes from one luminaire. The term “dynamic light recipe” is a light recipe which changes (spectrum and intensity) as a function of time, where time is expressed in units relevant for horticulture growth processes. The term “growth stage dynamic light recipe” is a dynamic light recipe which will change over time as a function of the growth stage or the leaf area index of the plant. “Leaf area index (LAI)” is a known parameter used by growers to measure the plant growth stage and performance. It is a dimensionless quantity defined as the one-sided green leaf area per unit ground surface area. There is a direct relation between LAI and light interception which is used to predict the primary photosynthetic production in canopies. “Red light” is considered radiation in a wavelength range from about 620 nm to about700 nm; “blue light” is considered radiation in a wavelength range from about 400 nm to about 500 nm; and “far-red light” is considered radiation in a wavelength range from about 700 nm to about 800 nm. The term “light quality” refers to the spectral distribution of the light. The term “PAR” stands for photosynthetically active radiation and designates the spectral range of solar radiation from 400 to 700 nm. The term “PSS” refers to phytochrome stationary state as defined in the publication “Photosynthetic efficiency and phytochrome photoequilibria determination using spectral data” J. C. Sager etal 1988 American society of agriculture engineers 001-2351/88/3106-1882. PSS is established by multiplying the irradiance at each wavelength against the relative absorption at that wavelength for each form of phytochrome (r-phytochrome and fr-phytochrome). The term “daily light integral (DLI)” is the amount of PAR light received each day as a function of light intensity (instantaneous light in μmol/m2.s) and duration (day). It is expressed as moles of light (mol) per square meter (/m2) per day (/d) or mol/m2.d.

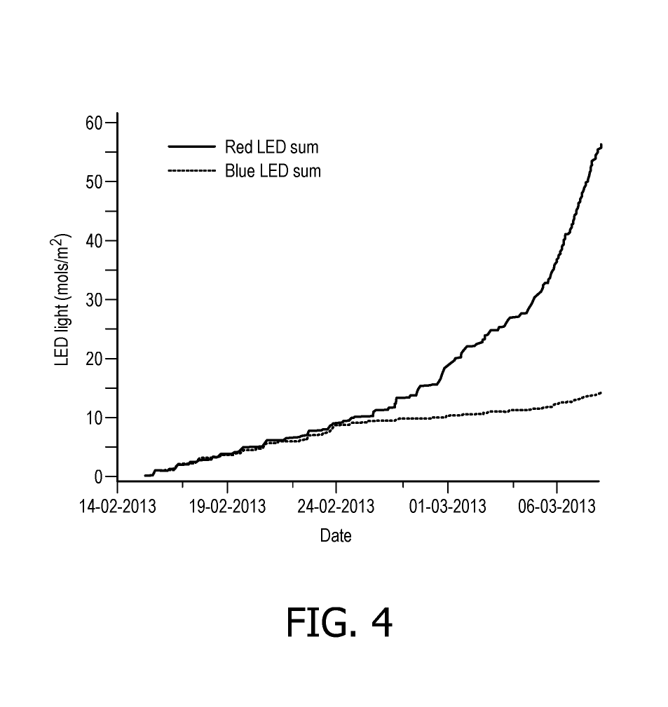

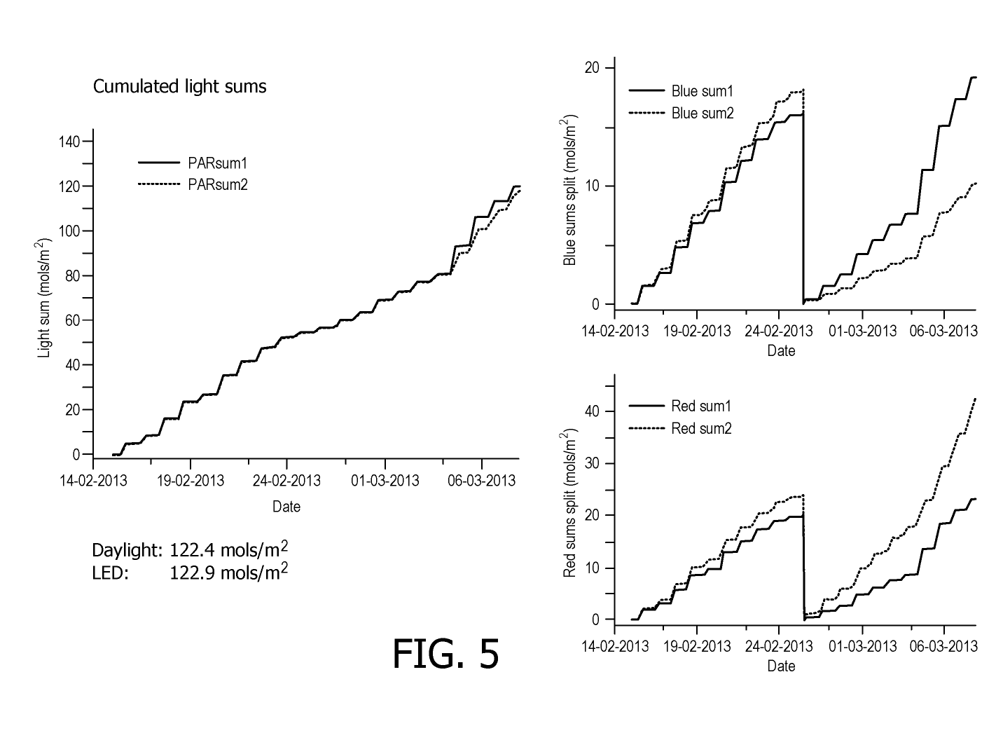

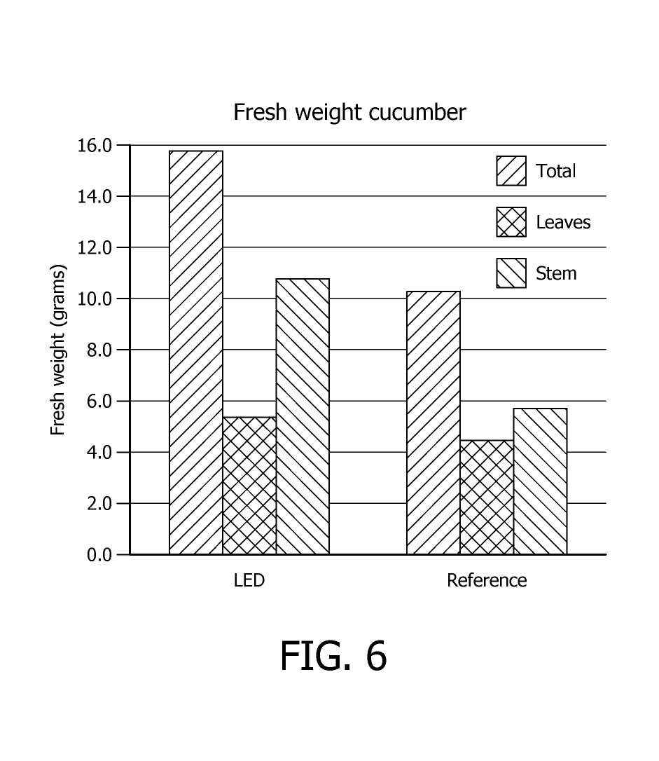

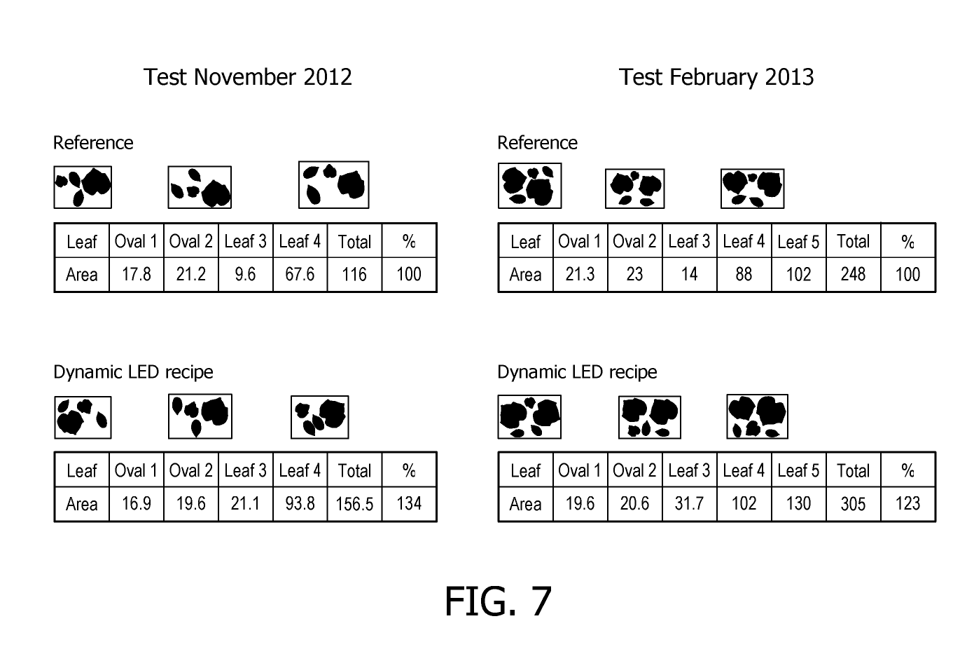

The inventors have performed a series of experiments using sensor controlled LED lighting to test several hypothesis on dynamic light recipes. The experiments were repeated and checked multiple times on many replicates of plant seedlings. The dynamic growth stage dependent recipe included the growing of small cucumbers plant seedlings from seeds during a period of 2 to 3 weeks under two different light qualities. A first light quality would have predominance in blue compared to red (e.g. a blue/red ratio of 50/50) while a second light quality would have the blue percentage reduced to 20% or less compared to the total amount of light (e.g. a blue/red ratio of 20/80). In the experiments, the first light quality was applied during a first period in the seedling growth process and the second light quality was applied during a second period in the seedling growth process, following the first period. The accumulated light dose in mols/m2 (photons per unit area) received by the plant seedling in the above dynamic light recipe is schematically depicted in FIG. 4. Seedlings grown under LED illumination (“test”) were then compared with seedlings grown under 100% daylight (“control”). Both test and control seedlings had received the same intensity of light, only the quality was different (i.e. different blue/red ratio). PSS was kept the same as it is known that PSS could strongly influence the morphology of a plant. Results obtained from experiments done in autumn and in winter were similar and gave the same trends. FIG. 5 shows the light history during the experiments for the test seedlings (red) and control seedlings (black). The Light Sums represent the total amount of PAR light measured with a PAR sensor. PARsum1 (black curve) is derived from data collected by a sensor in the control experiment with daylight and PARsum2 (red curve) is derived from data collected by a sensor in the test experiment with LEDs. From the data so collected, the inventors calculated the total daily light integral (mol/m2 per day). The graphs in FIG. 5 show cumulated daylight sums over the whole period of the experiments (20 days). The graph on the left shows that both the control experiment and test experiment applied very similar amounts of PAR light during the experiments. The graphs on the right show separately the amount of blue respectively red in the light applied in the experiments. Because there is a significant difference in the light recipe quality, the cumulated sum for the first period and the cumulated sum for the second period are shown with a reset to zero in between. This representation better illustrates the different blue/red ratio's in the first respectively second light period. The curves illustrate an almost 50-50% blue and red contribution in the first period of the experiment, while in the second period the amount of red in the test experiment is strongly increased while the blue in the test experiment is decreased compared to the daylight in the control experiment. Note that in the test experiments where the inventors used a dynamic light recipe provided from a LED luminaires, there was a small contribution of daylight present. In daylight there is generally about 35% green, 38% red, 27% blue. The ratio red/blue in daylight is therefore about 1.4. In the dynamic light recipe used in the experiment, the ratio used in the first period of the grown process was a bit lower (1 to 1.25) because the inventors used more blue than available in natural daylight during this first period in the growth process. So, in practice, when a grower would use a significant amount of daylight contribution, he would have to add more blue to adjust the light recipe in the first phase of the growth process and a lot more red in the second phase of the growth process in order to obtain similar results. A significant advantage of the dynamic LED illumination using the dynamic light recipe described above was that the seedlings grown using a dynamic light recipe showed an increase in total biomass (up to 50%) with a similar dry weight percentage. The morphology was also influence as the test seedlings had up to 30% increase in LAI. FIG. 6 shows the fresh weight increase due to dynamic light recipe (test) versus daylight illumination (control). FIG. 7 shows leaf area index (LAI) increase in the experiments on cucumber seedlings and compares test and control seedlings.

The inventors also performed experiments with static light recipes i.e. light recipes providing artificial light that it not changed as a function of the horticulture growth process to compare these with 100% daylight. These experiments were conducted in July and October 2012. The experiments showed similar total biomass and similar LAI for both static light recipes and 100% daylight. Although the light quality provide by the static light recipes did not change between different stages in the growth of plant seedlings, these recipes do include a day/night rhythm. Most seedlings need a day/night rhythm. The night time typically is 6 hours minimum and may for example follow the natural sunrise/sunset rhythm. However, in winter season when the days are shorter, the light recipes may provide artificial grow light beyond the natural daytime period e.g. continue after sunset. Of course, growers will not try to create summer daylight conditions during the winter season; this would not be cost efficient. A minimum daily light integral is usually defined to balance growth and energy cost. So, in view of the above, light recipes may be designed to provide a daily dose of photon energy having a certain wavelength spectrum to the plant seedlings. In a preferred embodiment, in the presence of daylight, a daily light integral may be measured and taken into account when executing the light recipe such that the amount of accumulated light per day received by the plant seedlings is more or less constant irrespective of sunny or cloudy days. This may be achieved by dimming up or down and/or adjusting the spectrum of the artificial light sources in dependence on the measured daily light integral. In horticulture environments having no or very limited natural daylight entry, such as in city farms, the average daily light integral created by artificial light and the daylight (if any) is usually above what the average natural daily light integral would be.

In conclusion, dynamic light recipes providing a larger percentage of blue in an early stage of the growth (in the experiments these were the stages of seed leaves growth and first true leaf growth) create a boost of LAI and biomass production for seedlings. When the dynamic light recipes switch to less blue and more red in later stages (in the experiments these were the stages of further leaves growth) having already boosted the leaf area in earlier stages, the growth is now further optimized for photosynthesis and overall growth.

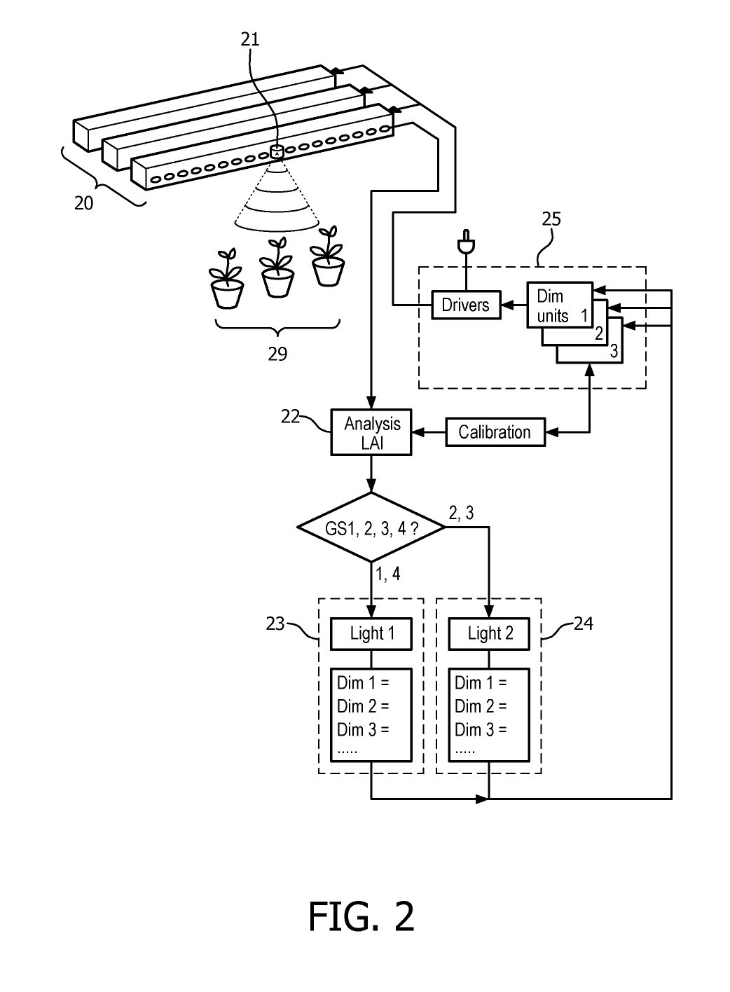

FIG. 2 shows an embodiment of a lighting system for implementing a dynamic light recipe. A series of LED luminaires 20 is provided with separately dimmable blue, red and far-red emission. Each LED luminaire may be designed to emit all three colors (blue, red and far-red), wherein each color is individually dimmable. Alternatively the system may comprise individual LED luminaires per color, each luminaire being individually dimmable, wherein the luminaires are positioned in close proximity to as to be able to provide a combination of blue, red and far-red in each location. Instead of, or in addition to, the bar-shaped luminaires shown in FIG. 2 the system may also comprise tile-shaped luminaire similar to ceiling tile luminaires. At least one of the LED luminaires comprises a sensor 21 for monitoring the growth of the plant seedlings 29, e.g. by means of a LAI sensor. The data from the LAI sensor is analyzed in processor 22 and based on the results of the LAI data it is determined in which stage of the growth process the plant seedlings are. In this particular example, if the actual growth stage is GS2 or GS3, representing seed leaves growth respectively first true leaf growth, then light recipe 2 with appropriate dim values DIM1, DIM2 and DIM3 values for dimming blue, red and far-red LEDs is selected (24) so as to obtain the correct ratios of blue/red and red/far-red illumination from the LED luminaires. The dim values are then provided to the LED luminaire drivers 25 for effectively controlling the LED luminaires to emit the requested blue, red and far-red radiation. If in this particular example the actual growth stage is GS1 or GS4, representing root and shoot development respectively further leaves development, then light recipe 1 with appropriate dim values DIM1, DIM2 and DIM3 values for dimming blue, red and far-red LEDs is selected (23) so as to obtain the correct ratios of blue/red and red/far-red illumination from the LED luminaires. The dim values are then provided to the LED luminaire drivers 25 for effectively controlling the LED luminaires to emit the requested blue, red and far-red radiation. The skilled person will appreciate that dimming of LED luminaires can be implemented in various ways. FIG. 2 shows three DIM UNITS in block 25 for dimming blue, red and far-red respectively. The three DIM UNITS shown do not necessarily link to the three LED luminaires in a one-to-way relation. If for example each LED luminaires includes blue, red and far-red LEDs, then each LED luminaire will be driven from all three DIM UNITS. However, if each LED luminaire includes only LEDs of the same color, then the LED luminaire with the blue LEDs may be driven by the blue DIM UNIT, the LED luminaire with the red LEDs may be driven by the red DIM UNIT and the LED luminaire with the far-red LEDs may be driven by the far-red DIM UNIT.

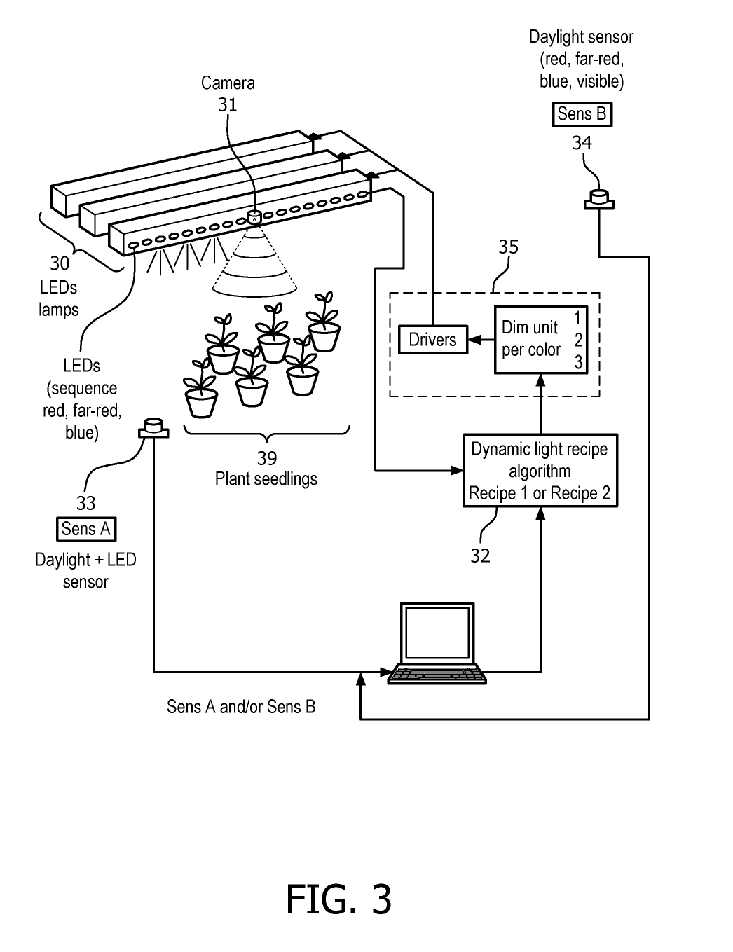

The embodiment shown in FIG. 3 shows a lighting system for implementing a dynamic light recipe in greenhouses where a feedback loop from one or more light sensors is used to compensate daylight changes in red/far-red ratio, blue/red ratio and PSS value. The set-up displayed in FIG. 3 includes of at least 3 LED luminaire 30, each comprising red, far-red and blue LEDs which are independently dimmable. An input signal from a camera 31 may be used to collect images of plant seedlings 39. The actual growth stage may then be calculated and the appropriate value of light ratios may then be determined by the dynamic light recipe algorithm in processor 32. Dim values may then be sent to the controller and driver 35 of the LED luminaires 30. Alternative, instead of fully automatically determining growth stage and switching light recipes, the images of plant seedlings and the calculation of LAI may be sent to the grower who then autonomously decides when to switch to the another light recipe. This alternative embodiment provides the growers with the possibility to try out and fine tune the dynamic light recipes and the timing. One or two light sensor 33, 34 could be used to control the overall light received by the plant seedlings when both the LED luminaires and daylight significantly contribute to the seedling illumination. It has been shown that when the daylight amounts for more than 20% of total light arriving on the plant seedlings per day, then it is preferred to actively control the red/far-red ratio and the blue/red ratio as well as the PSS value to ensure a correct light quality treatment. The one or two sensors may be used in the control of the light quality of the overall amount of light received by the plant seedling. When only one sensor is used, e.g. sensor 34, capable of sensing light quantities in different spectral ranges, then light ratios blue/red and red/far-red and intensities of the daylight may collected and therefrom the desired light ratios and intensities for the LED light are calculated and fed to the controller 35 for driving the LED luminaires 30 such that the sum of the daylight and LED light received by the plant seedlings 39 complies with the settings of the light recipe. A calibration of the LEDs may be advantageous to ensure a correct computation of ratios, amount of daylight, total intensity of combined daylight and LED light etc. In the particular embodiment where only sensor 34 is used, the shadowing of the daylight by the LED luminaires is not taken into account as there is no sensor under the LED luminaires to measure the actual daylight received by the plant seedlings. Such a sensor may be readily provided as additional sensor 33. Also sensor 33 may capable of sensing light quantities in different spectral ranges. When two sensors 33, 34 are used, the system does not need a sophisticated or regular calibration and the algorithm for determining the dim values for the LED luminaires can directly compensate the daylight changes and shadowing in the control of the LED drivers per color or spectral range. Using a system as shown in FIG. 3 the dynamic light recipe algorithm may opt for the most efficient use of the daylight, e.g. use 100% daylight on sunny days and compensate on days when there is less daylight by switching LEDs to higher intensity values and also possibly extend the length of day to match the energy received by the plant seedlings on days when daylight was very high in a way that the daily light integral is more or less constant which allows for a more constant and predictable seedling production.

In general, embodiments of lighting systems for implementing a dynamic light recipe may comprise one or more or any combination of the following features:

A light source containing a multitude of monochromatic emitting lamps (LED, OLED or laser based lamps or other lamps with filters) that emits radiation in the red (620 nm to 700 nm) in the blue (400 nm 500 nm) and in the far-red (700 nm 800 nm) wavelength range. Each individual color or wavelength range could be spectrally defined with a bandwidth from 10 to 100 nm;

A light source having at least one sensor to monitor daylight composition and adjust lighting recipes by dimming at least 3 channels (red, far-red, blue) to give precise ratios between red/far-red and blue/red with a specific PSS range.

A sensor system able to measure daylight intensity in at least 3 different color ranges (from about 400 nm to about 500 nm for blue, about 600 nm to about 700 nm for red and about 700 nm to about 800 nm for far-red)

A light source having a broadband emission spectrum (e.g. using phosphors). In such case ratios between red, blue and far-red could be calculated as well. These light sources may for example be used to provide an illumination with known color ratios and a controllable baseline intensity, on top of which controllable LEDs may be used to tune the color ratios and intensities.

A light source, luminaire or system wherein each single color (blue, red and far-red) is independently controllable and/or dimmable.

Automatic detection of the plant seedling growth stage by daily estimation of LAI using a webcam or other pixelated sensor.

Estimation of plant seedling growth stage based on light integral and temperature integral from a modeling tool.

A plant monitoring system (webcam or a device such as the PlantEye from the company Phenospex B.V. in the Netherlands for detecting the growth stage of the plant in combination with a light control system to adapt the light quality according to the growth stage.

The dynamic lights recipes may comprise:

A far-red radiation component such that the PSS value of the LED light is comparable to the PSS of daylight (about 0.72).

In the plant growth stages of developing the seed leaves and developing the first true leaf, the light recipe has a predominance of blue making the ratio of red to blue intensity close to 1 wherein additionally the total intensity combination of red, blue and far-red provides a PSS value near the natural daylight PSS value.

While the invention has been illustrated and described in detail in the drawings and foregoing description, such illustration and description are to be considered illustrative or exemplary and not restrictive. The invention is not limited to the disclosed embodiments.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program for executing the light recipes disclosed herein may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to include any specific characteristics of the features or aspects of the invention with which that terminology is associated.

1. A method for growing plant seedlings comprising the steps of:
providing at least one plant seedling;
determining a growth stage of the at least one plant seedling, wherein a growth stage is a phase in a development process of the at least one plant seedling;
controlling the spectral composition of a grow light for illuminating the at least one plant seedling, based on the determined growth stage; and
illuminating the at least one plant seedling with the grow light, where the step of controlling the spectral composition of the grow light comprises providing additional blue light in a chronologically earlier growth stage compared to a chronologically later growth stage.

2. (canceled)

3. The method of claim 2, wherein the growth stage is one of a root and shoot stage, a seedling leaf development stage, a first true leaf development stage and a further leaves development stage; and wherein the chronologically earlier stage is one of the seedling leaf development stage or the first true leaf development stage.

4. The method of claim 2, wherein the step of controlling the spectral composition of the grow light comprises controlling a blue/red radiation ratio; and the step of providing additional blue light comprises controlling the blue/red radiation ratio of the grow light to be more than about 20/80, preferably about 50/50.

5. The method according to claim 1, wherein the step of determining a growth stage of the at least one plant seedling comprises measuring a leaf area index.

6. A system for growing a plant seedling comprising:
a light source for emitting grow light for growing a plant seedling;
a sensor for measuring a property of the plant seedling;
an analyzer for determining a growth stage of the plant seedling based on the measured property of the plant seedling; and
a driver for controlling the light source based on the growth stage of the plant seedling,
wherein the driver is adapted for controlling the light source such that the grow light emitted from, light source comprises additional blue light during a chronologically earlier growth stage of the plant seedling compared to a chronologically later growth stage.

7. (canceled)

8. The system of claim 6, the light source further comprises at least one intensity controllable blue emitting light source, preferably a blue LED, and at least one intensity controllable red emitting light source, preferably a red LED; and wherein the driver is further adapted to control a blue/red radiation ratio of the emitted grow light such that additional blue light is provided in a blue/red radiation ratio of more than about 20/80, preferably about 50/50.

9. The system of claim 6 wherein the sensor is adapted to measure a leaf area index of the plant seedling.

10. The system of claim 6, further comprising at least one light sensor for measuring a spectral composition of daylight; wherein the driver is further adapted for controlling the light source based on the composition of daylight.

11. A light recipe for controlling at least one light source for illuminating a plant seedling with grow light, the light recipe comprising:
a specification of at least two different light setting comprising a different blue/red radiation ratio;
a specification of at least two growth stages for identifying at least two phase in a chronological development process of the plant seedling;
wherein the specification of the light setting comprising the highest blue/red radiation ratio is assigned to the earlier of the at least two growth stages in the chronological development process of the plant seedling.

12. A data carrier comprising a light recipe according to 11 which when executed on a system for growing a plant seedling performs a method for growing plant seedling.
